(19) United States
(12) Patent Application Publication
(10) Pub. No.: US 2005/0168660 A1
(43) Pub. Date: Aug. 4, 2005

(54) Digital moving picture device

(76) Inventor: Mircea Popescu, Lawrenceville, NJ (US)

Correspondence Address: MIRCEA POPESCU, 6222 TOWN CT. N., LAWRENCEVILE, NJ, 08648, US

(21) Appl. No.: 11/045,771

(22) Filed: Jan. 28, 2005

Related U.S. Application Data
(60) Provisional application No. 60/539,732, filed on Jan. 29, 2004.

(51) Int. Cl. H04N 5/64

(52) U.S. Cl. 348/790; 348/836

(57) ABSTRACT

Digital Moving Picture Device plays on an equipped CD ROM drive looped MPEG compressed video audio and displays on an equipped LCD both held in a case with other electronic components and is designed to be mounted on walls as an electronic version of the wall picture.

This application claims the benefit of U.S. Provisional Application No. 60/539,732 filed on Jan. 29, 2004. Title: Digital Moving Picture Device

### BACKGROUND OF THE INVENTION

1. Field of Invention

The present invention relates to an electronic apparatus able to read digital data audio and video stored in a Compact Disc played in an equipped standard CD drive and displayed on an equipped Liquid Crystal Display. The audio and video are compressed using MPEG technology and designed to be played loop on the display. This device might be an electronic version of the traditional wall picture

2. Description of Related Art

It is known that digital media is being developed a lot in the recent years. Conventional media such as video tape or roll film are less and less used by consumers transforming the digital media into the main form of expression in many industries.

The time difference between old generation of electronic components and the new generation is a matter of months not years. In this way parts manufactured with advanced technologies become with no use in a very short time, placing many companies in a difficult situation. It is usual to be conducted a search of patents in appropriate classes and subclasses of U.S. patents on file, in the patent search facilities of the Patent and Trademark Office. The search conducted by registered patent attorneys located the following patents of interest:

| | |
|---|---|
| 4,308,557 | Dieterich |
| 4,357,628 | Wharton |
| 4,419,699 | Christopher et al |
| 4,535,366 | Pullen |
| 4,866,540 | Okatani |
| 4,951,155 | Andrews |
| 5,146,347 | Kawakami et al |
| 5,438,344 | Oliva |
| 5,504,836 | Loudermilk |
| 5,617,386 | Choi |
| 5,703,624 | Van Kruistum |
| 5,761,458 | Munyan |
| 5,787,223 | Faryar et al |
| Des. 396,351 | Patkunan |
| 5,812,899 | Mc Intyre |
| 5,825,408 | Yuyama et al |
| 5,851,878 | Arnold et al |
| 5,842,672 | Sweere et al |
| 5,899,582 | DuLac |
| 6,016,166 | Huang et al |
| 6,141.004 | Jeong |
| 6,246,573 | Khan et al |
| 6,272,147 | Spratt et al |
| 6,396,472 | Jacklin |
| 6,418,273 | Lubinski et al |
| 6,480,243 | Yamamoto |
| 6,522,368 | Tuccinardi et al |
| 6,535,139 | Lindler |
| 6,628,963 | Chung |
| 6,717,567 | Bowden, III et al |
| 6,741,795 | Takeido et al |

Careful consideration has been given to the patents located in the search. This review indicates that some but not all of the aspects of the above invention are already shown in existing patents. That is, the above referenced patents do not seem to suggest the full extent of the disclosed invention. Some of the above patents need to be mentioned to create the difference between the present invention and all the others.

U.S. Pat. No. 6,480,243 discloses an “Installation Structure For Panel-Type Display Device” showing some but not all the concepts of the present invention. U.S. Pat. No. 6,535, 139 shows an “Electronic Picture Viewing Apparatus. The “Digital Display Picture Frame which is U.S. Pat. No. 396,351. A separate device, along with a process for displaying images and sounds is shown in U.S. Pat. No. 6,396,472. A “Portable Video Book” is shown in U.S. Pat. No. 5,438 344. See the “Picture Frame with Associated Audio Message” which is the subject of the U.S. Pat. No. 5,504,836. A “Portable Vehicle Video System” is shown in U.S. Pat. No. 6,522,368. See the “Computer with Portable Display” of U.S. Pat. No. 6,246,573. A “Portable Multimedia Player” which can sit on a table or be mounted an a wall is shown in U.S. Pat. No. 6,628,963. See the “Multimedia Displayable Collective Device” of U.S. Pat. No. 5,841,878. A” Wireless Digital Picture Display Frame is shown in U.S. Pat. No. 6,717,567 being mountable to a wall. See the “Mounting System For Panel Display Keyboard and Stand” which is the subject of U.S. Pat. No. 5,842,672.A “Method And Apparatus For Providing An Automated Narration For A Plurality of Images” is shown in U.S. Pat. No. 5,812,899

### SUMMARY OF THE INVENTION

A novel invention that brings something totally new, an electronic version of the traditional wall picture.

1.It is the object of the present invention to provide an apparatus able to display on an equipped Liquid Crystal Display digital audio video stored in a Compact Disc and played in a Compact Disc Drive.

2. It is another object of the present invention to provide the said apparatus that combines a technical function being a machine and has a decorative and environmental destination. The MPEG compressed will be looped to make possible to be played for a long time. The themes such as; ocean waves, lakes, mountain rivers, water falls, creeks, sky, etc will create a nice and relaxing environment for homes or for institutions developing the digital video industry in the same time.

3. It is still another object of the present invention to provide the said apparatus, which is designed to work for a long time, with a coated screen that creates protection for possible electromagnetic emissions.

4. It is still another object of the present invention to provide the said apparatus with installation parts that permit mounting on walls.

5. It is still yet another object of the present invention to provide the said apparatus that is able to function for a long time having the power supply attached under the installation parts in a box between wall and the said apparatus permitting in this way a better ventilation.

6. It is another object of the present invention to provide the said apparatus to use mostly old generation parts and in this way the production cost will be low being affordable by large numbers of consumers.

### BRIEF DESCRIPTION OF THE DRAWINGS

The enclosed drawings illustrate the important parts of present invention and give detailed information how the apparatus will look and function.

FIG. 1 is a perspective view of the Digital Moving Picture Device viewed from the front and the side.

FIG. 2 is a view of the said Digital Moving Picture Device viewed from the top.

FIG. 3 is a view of the Digital Moving Picture Device viewed from the side.

FIG. 4 is an exploded perspective view of the Digital Moving Picture Device

### DETAILED DESCRIPTION OF THE PREFERED DRAWINGS

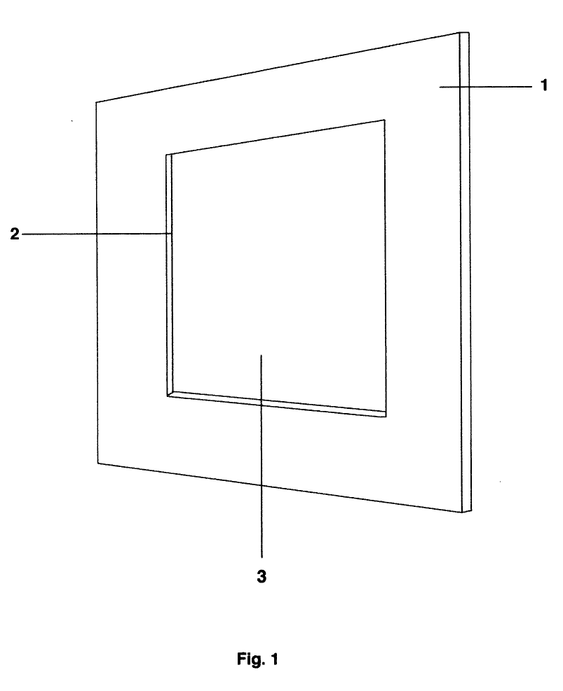

FIG. 1 shows a perspective view from the front and side of Digital Moving Picture Device and will be explained below.

The transparent coated acrylic panel 1.will protect the viewer from possible electromagnetic emissions. The metal part 2. which is seen through the coated acrylic has the function to create a neutral background for the liquid crystal display 3.

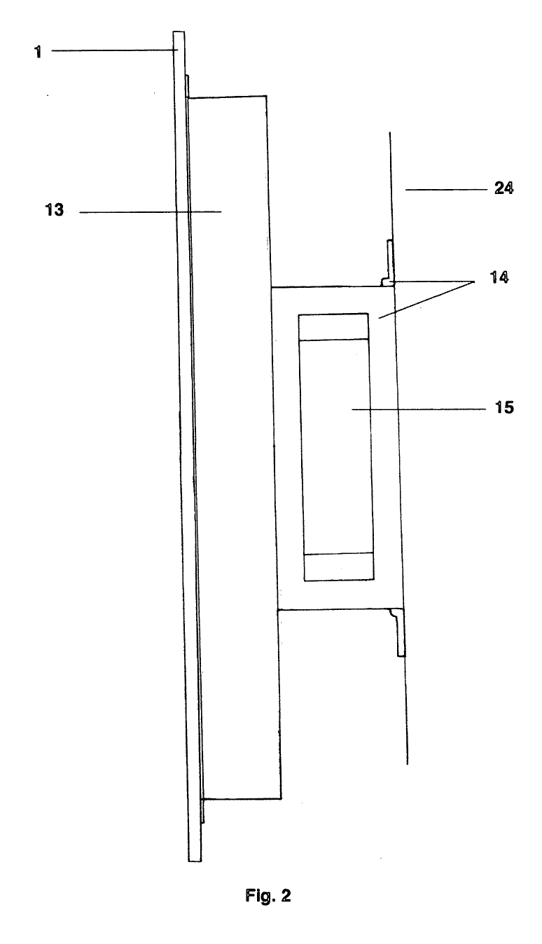

FIG. 2 is a top view of the present invention showing the metal part 2 which is attached to case 13 that is the housing of the electronic parts It has also attached the mounting parts 14 which protects the power supply and the motor fan 15.

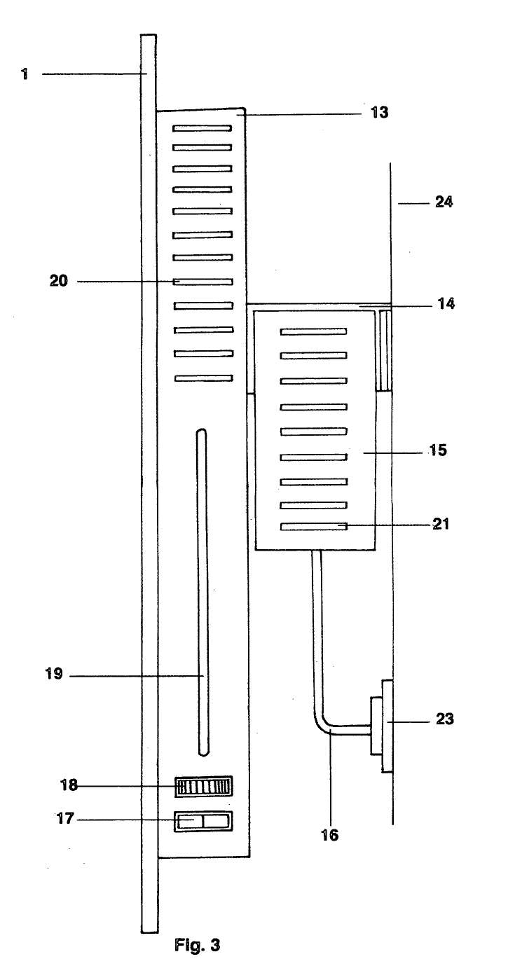

FIG. 3 is a side view of the Digital Moving Picture Device. It shows the coated acrylic panel 1, the case 13 which has ventilation spaces 20. The case 13 has also the Compact Disc slot 19. At the bottom of the case 13 there are two buttons, the power switch 17 with two positions “on” and “off” and the volume button 18. The view also shows the mounting parts 14 and the power supply 15. The power supply has also ventilation spaces 21. The electric cord 16 is also seen in the view, the wall socket 23 and wall 24.

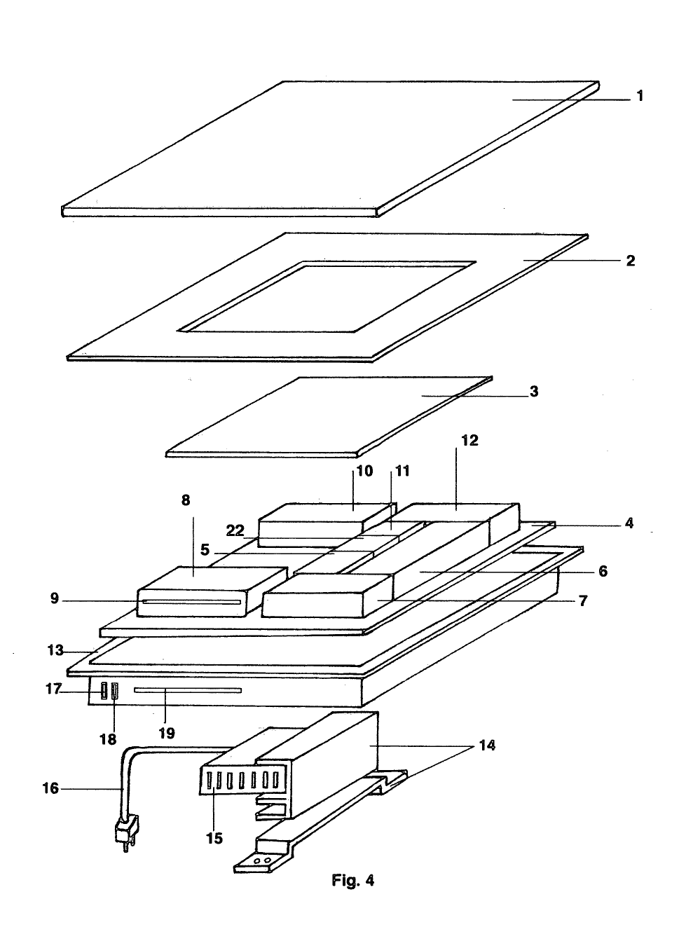

FIG. 4 is a exploded perspective of the Digital Moving Picture Device. The metal part 2 is the support for the coated acrylic 1 and is attached to the liquid crystal display 3. From the metal part 2 which has an opening is attached the case 13 which holds all the electronic parts, The motherboard 4 interconnect different electronic parts circuitry which receive power and pass control signals and data to each of them, is also attached to the case 13.

A compressed video audio MPEG (Motion Picture Experts Group) played by the CD-Rom drive 8 is directed to a video card 10 which has a video processor included. The information is then directed to the liquid crystal display 3. Video RAM (random access memory) 5 makes possible the video processor to perform all operation for display. Digital LCD 3 has to be matched with the video card 10 which has to be capable to produce digital output for the display.

The device has to read only digital data using the same application program with the same settings and perform the same resolution and color depth.

CPU 22 (Central Processing Unit) made out of many parts that work together to transfer information to different components could be an old generation.

The moving of data and executions of instruction has to be synchronized by a clock Video BIOS basic input/output system 11 provides interface between the application program to the video card 10 and the LCD 3. It also operates all functions the device needs to get started. Sound card 6 uses 16-bit sound resolution the same used by the CD-ROM drive.

The sound card 6 comes with a set of speakers 7 and 12 and an amplifier.

FIG. 4 shows also the mounting parts 14 and the power supply 15 placed below.

1. A Digital Moving Picture Device comprising:
An apparatus capable to read and play a looped MPEG (Moving Picture Experts Group) compressed, video and audio and displays the digital content on an equipped LCD (liquid crystal display)
a method of receiving MPEG compressed and capacity to perform all operations for display.
a digital LCD which has to be matched with the video card which has to be capable to produce digital output for the display.
reading only digital data using the same application program with the same settings, perform the same resolution and the same color depth.
a system that provides interface between the application program to the video card and to the display.

2. An apparatus for reading and displaying digital images comprising:
a power supply placed between the case and wall for a better ventilation, capable to function for a long time.

3. An apparatus for reading and displaying digital images comprising:
looped MPEG compressed displayed on the equipped LCD which is held in a case and is designed to be mounted on walls and function as an electronic version of the wall picture.
